(19) United States
(12) Patent Application Publication
(10) Pub. No.: US 2011/0113640 A1
(43) Pub. Date: May 19, 2011

(54) Chassis Gauge

(76) Inventor: Lou Molina, Dorrigo (AU)

(21) Appl. No.: 12/943,924

(22) Filed: Nov. 10, 2010

Related U.S. Application Data
(60) Provisional application No. 61/261,354, filed on Nov. 15, 2009.

(51) Int. Cl. G01D 21/00; G01B 1/00

(52) U.S. Cl. 33/608

(57) ABSTRACT

A gauge device for assessing at least one alignment parameter associated with a motorcycle chassis. The motorcycle chassis having an axle shaft, a rear suspension swing arm and a pair of front fork suspension shock absorbers. The device comprising: an elongate member; a first locating element coupled to the elongate member and adapted to locate an axis of the axle shaft; a second locating element coupled to the elongate member and adapted to locate a rotation axis of the rear suspension swing arm; and a pair of alignment elements each coupled to the elongate member, each of the pair of alignment elements being adapted to locate an axis of a respective one of the front shock absorbers. A linear distance measurement element is coupled to the elongate member for indicating relative movement between elements. The device being adapted to assess at least three alignment parameters associated with a motorcycle chassis, the alignment parameter comprising: parallelism of front shock absorbers, rear axle alignment as indicated by distance between the axle shaft axis and the rotation axis of a rear suspension swing arm, and any one or more of rear suspension ride height, static sag and race sag.

### FIELD OF THE INVENTION

The present invention relates to gauges and in particular to mechanical alignment gauges.

The invention has been developed primarily for use as a mechanical gauge for assessing the alignment of a motorcycle chassis and will be described hereinafter with reference to this application. However, it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

It will be appreciated that to achieve peak performance from a motorcycle requires accurate alignment (or adjustment) of wheels and suspension. This alignment includes setting the front forks to be parallel, rear wheel alignment, and rear suspension ride height.

Independent tools are currently available to measure the front suspension fork-tube and rear suspension ride height. Whereas the rear wheel alignment is commonly only assessed using indexing on rear axle mounting on either side of the rear suspension swing arm, provided by the motorcycle manufacturer.

These adjustments can require measurement and/or indicative cues to the precision of a particular setting. Further these adjustments may be required on location, or away from a workshop.

### OBJECT OF THE INVENTION

It is an object of the present invention to overcome or ameliorate at least one of the disadvantages of the prior art, or to provide a useful alternative.

It is an object of the invention in its preferred form to provide a mechanical gauge for assessing a plurality of alignment parameters associated with a motorcycle chassis.

### SUMMARY OF THE INVENTION

According to a first aspect of the invention there is provided a gauge device for assessing at least one alignment parameter associated with a motorcycle chassis. The motorcycle chassis preferably has an axle shaft, a rear suspension swing ante and a pair of front fork suspension shock absorbers. The device preferably comprises:
an elongate member;
a first locating element coupled to the elongate member and adapted to locate an axis of the axle shaft;
a second locating element coupled to the elongate member and adapted to locate a rotation axis of the rear suspension swing arm;
wherein relative location of the first locating element to the second locating element is adjustable for indicating the distance between the axle shaft axis and the rotation axis of a rear suspension swing arm for comparison at each side of the motorcycle.

The device further comprises:
a pair of alignment elements each coupled to the elongate member, each of the pair of alignment elements is adapted to locate an axis of a respective one of the front shock absorbers;
wherein relative location of the alignment elements is adjustable for indicating the distance between front shock absorbers and comparing distances at different locations along a length of the front shock absorbers.

According to a second aspect of the invention there is provided a gauge device for assessing at least one alignment parameter associated with a motorcycle chassis; the motorcycle chassis having an axle shaft, a rear suspension swing arm and a pair of front fork suspension shock absorbers; the device comprising:
an elongate member;
a pair of alignment elements each coupled to the elongate member, each of the pair of alignment elements is adapted to locate an axis of a respective one of the front shock absorbers;
wherein relative location of the alignment elements is adjustable for indicating the distance between front shock absorbers and comparing distances at different locations along a length of the front shock absorbers.

The device further comprises:
a first locating element coupled to the elongate member and adapted to locate an axis of the axle shaft;
a second locating element coupled to the elongate member and adapted to locate a rotation axis of the rear suspension swing arm;
wherein relative location of the first locating element to the second locating element is adjustable for indicating the distance between the axle shaft axis and the rotation axis of a rear suspension swing arm for comparison at each side of the motorcycle.

Preferably, the second locating element is adapted to abut a rear mud guard of the motorbike and movable for assessing any one or more of rear suspension ride height, static sag and race sag. Alternatively, at least one of the pair of alignment elements is preferably adapted to abut a rear mud guard of the motorbike and movable for assessing any one or more of rear suspension ride height, static sag and race sag.

Preferably the elongate member is telescopically extendable. More preferably, the elongate member comprises a first member element and a second member element, wherein the second member element is slidably engaged to the first member element. Most preferably, the second member element is adapted to slide within a bore or channel defined by the first member element. The first locating element is preferably fixedly attached to the first member element and the second locating element is preferably fixedly attached to the second member element, wherein relative location of the first locating element and second locating element is adjustable by sliding the second member element relative to the first member element. One of the pair of alignment elements is preferably fixedly attached to the first member element. The other of the pair of alignment elements is preferably slidably coupled to the first member element, whereby relative location of the alignment elements is adjustable by sliding the other of the pair of alignment elements along the first member element.

Preferably, a linear distance measurement element is coupled to the elongate member for indicating relative movement between elements. More preferably, relative movement between the elements can be directly measured by the measurement element. Most preferably, the linear distance measurement element is fixedly coupled to the second locating element, and the other of the pair of alignment elements is slidable to an origin measure of the measurement element such relative movement between the first locating element and the second locating element can be directly measured. Alternatively, the linear distance measurement element is fixedly coupled to the other of the pair of alignment elements and is slidable to locate the origin measure of the measurement element such relative movement between the first locating element and the second locating element can be directly measured. The linear distance measurement element preferably indicates both positive and negative displacement from the origin. A measurement site for marking the origin is preferably fixedly couplable to the elongate member such that the relative movement can be directly measured.

Preferably, the device comprises a first locking mechanism for restricting relative movement between a first member element and a second member element of a telescopically extendable elongate member. More preferably, the first locking mechanism further restricts relative movement between a first locating element and a second locating element.

Preferably, the device comprises a second locking mechanism for restricting relative movement between at least one of the pair of alignment elements and a portion of the elongate member. More preferably, the second locking mechanism further restricts relative movement between each of the pair of alignment elements.

According to a further aspect of the invention there is provided a gauge device for assessing at least three alignment parameters associated with a motorcycle chassis; the alignment parameter comprising: parallelism of front shock absorbers, rear axle alignment as indicated by distance between the axle shaft axis and the rotation axis of a rear suspension swing arm, and any one or more of rear suspension ride height, static sag and race sag.

According to a further aspect of the invention there is provided a method for assessing one or more alignment parameter associated with a motorcycle chassis, using the device as described herein. The alignment parameter preferably comprising: parallelism of front shock absorbers, rear axle alignment as indicated by distance between the axle shaft axis and the rotation axis of a rear suspension swing arm, and any one or more of rear suspension ride height, static sag and race sag.

### BRIEF DESCRIPTION OF THE D WINGS

A preferred embodiment of the invention will now be described, by way of example only, with reference to the accompanying drawings in which:

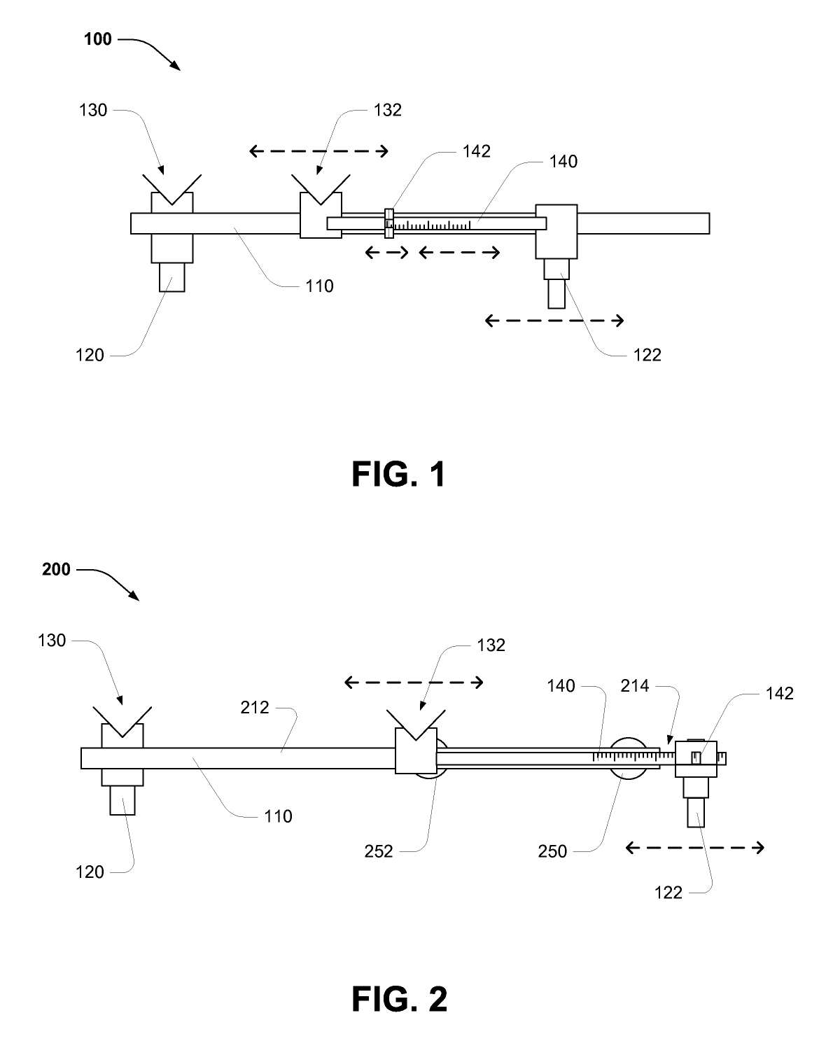

FIG. 1 is a side view of an embodiment gauge device according to the invention;

FIG. 2 is a side view of an embodiment gauge device according to the invention;

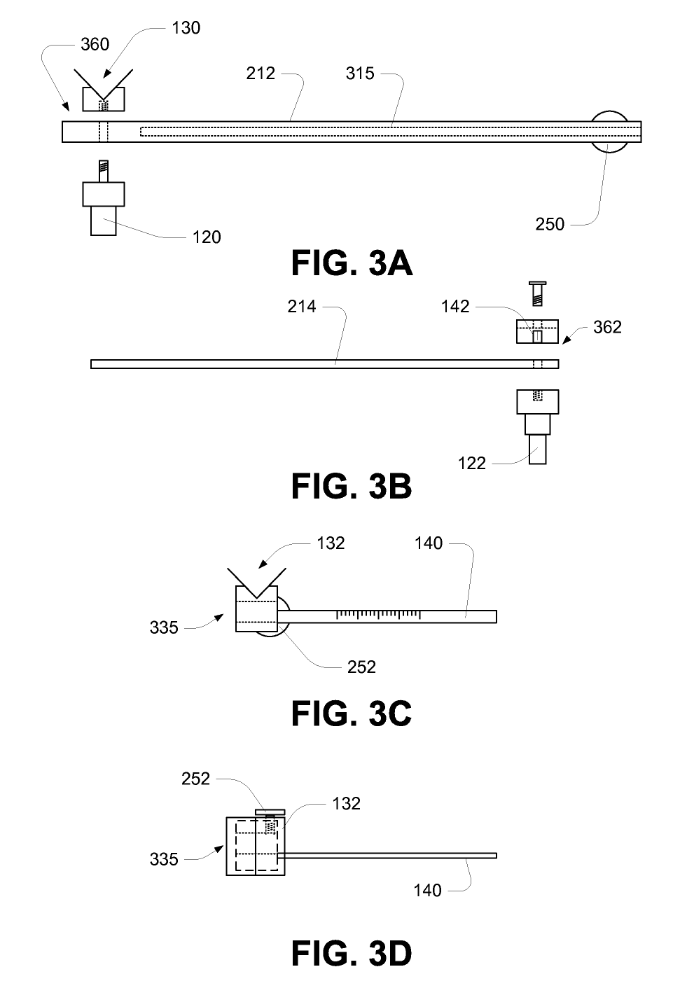

FIG. 3A is a side view showing a first locating element and one of a pair of alignment elements of the gauge device of FIG. 2;

FIG. 3B is a side view showing a second locating element of the gauge device of FIG. 2;

FIG. 3C is a side view showing the other of a pair of alignment elements and a linear distance measurement element of the gauge device of FIG. 2;

FIG. 3D is a plan view of the second locating element of FIG. 3C;

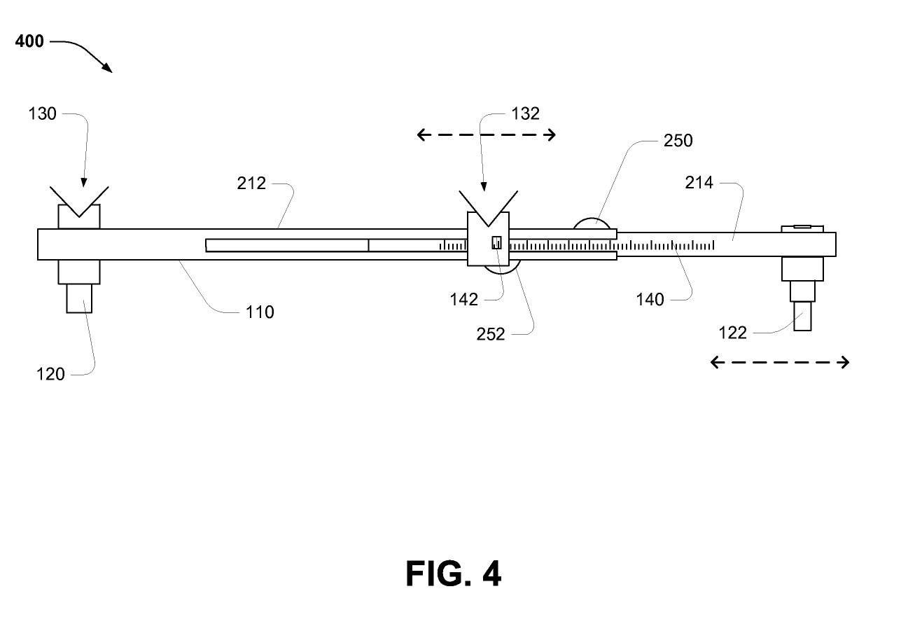

FIG. 4 is a side view of an embodiment gauge device according to the invention;

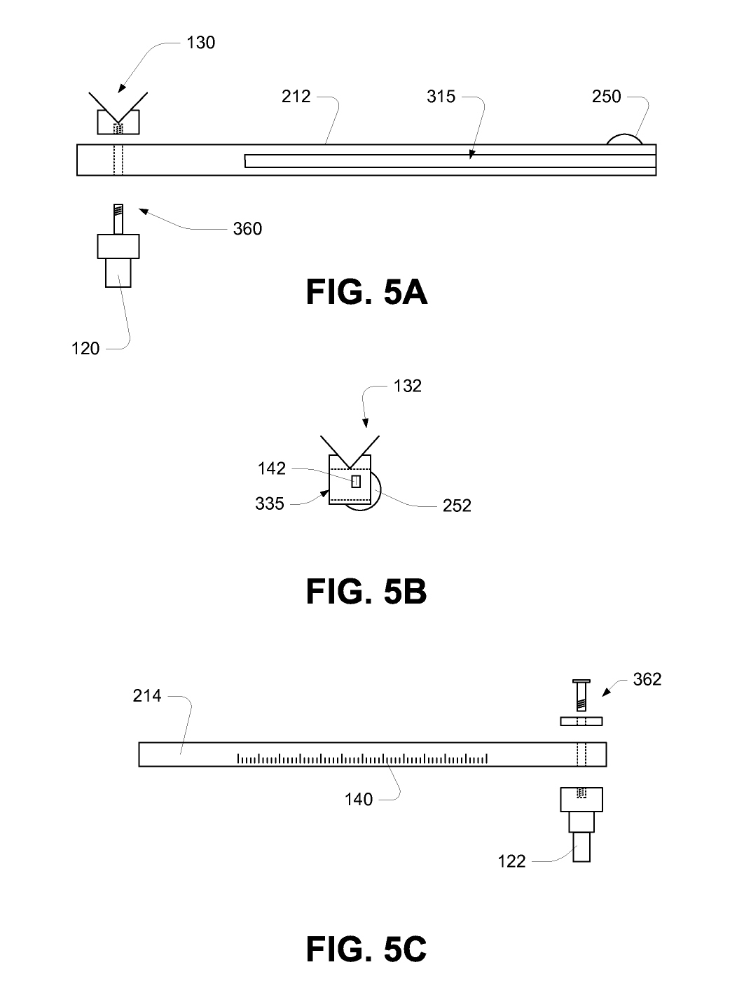

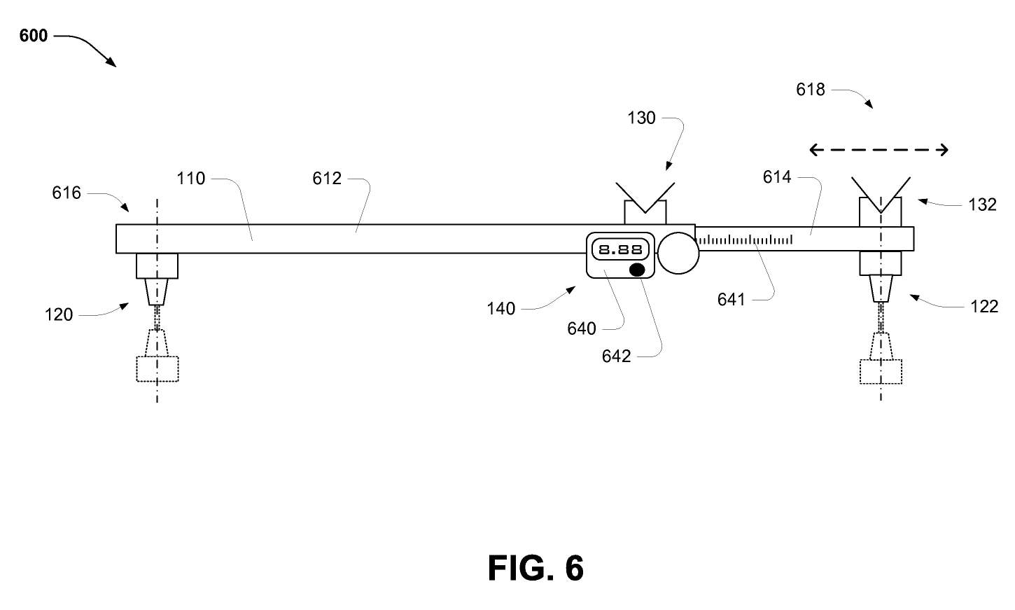

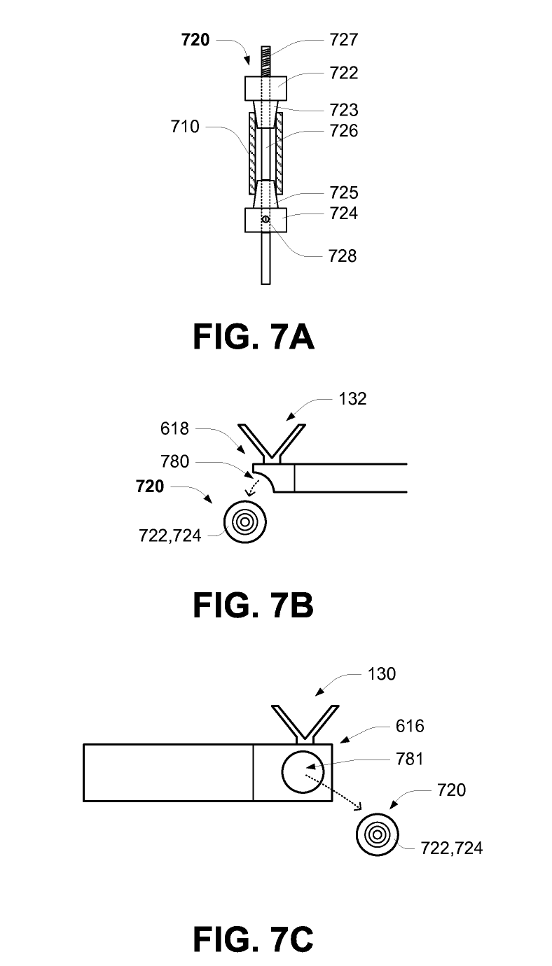

FIG. 5A is a side view showing a first locating element and one of a pair of alignment elements of the gauge device of FIG. 4;

FIG. 5B is a side view showing the other of a pair of alignment elements of the gauge device of FIG. 4;

FIG. 5C is a side view showing a second locating element of the gauge device of FIG. 4, showing a linear distance measurement element integrally formed with a second member element.

### PREFERRED EMBODIMENT OF THE INVENTION

It will be appreciated that correct rear wheel alignment, front shock absorber alignment, race sag and static sag can influence the handling of a motorbike.

The rear wheel is typically supported by a rear suspension swing aim. Alignment of this rear wheel can be determined by setting the distance between the wheel axle shaft axis and the rotation axis of a rear suspension swing arm to be the same for each side of the motorcycle.

The standard motorcycle front fork assembly typically provides front shock absorption using a pair of hydraulic shock absorbers. Each of these hydraulic shock absorbers comprise a hydraulic filled cylinder having a piston assembly working inside the cylinder. Alignment of the pair of hydraulic shock absorbers requires they are parallel. As each hydraulic shock absorber is formed from two or more co-axial cylindrical structures of different radii, alignment can be determined by assessing the relative axial alignment (or relative separation) between shock absorbers at different locations along their length.

Race sag is typically set such that the suspension works in its most effective range and to keep a good chassis weight balance, front to rear. Race sag can significantly affect overall handling traits of a motorcycle.

Determining proper suspension adjustment requires setting of rear spring preload, so that the proper ride height, or race sag dimension, is achieved. This can be checked and/or adjusted before each ride to ensure it remains at a predetermined setting. Typically the bike is set to normal racing weight—correct fuel, transmission oil and coolant levels.

Race sag is a measured difference in height between the unloaded dimension when a motorbike is supported with the rear wheel off the ground, and loaded dimension with a rider aboard (in race configuration). A measured distance (in line with the arc of the axle) from the rear axle to a fixed point on the motorbike (for example a location on the fender) is typically taken for the unloaded dimension and loaded dimension and the difference taken. The spring preload can be adjusted to achieve a predetermined race sag necessary to obtain the correct handling results.

Static sag is typically used to help determine the proper spring rate. This static sag is a comparative measure of the rear suspension sag between an unloaded dimension and the weight of the sprung portion of the bike alone (without a rider's weight). A measured distance (in line with the arc of the axle) from the rear axle to a fixed point on the motorbike (for example a location on the fender) is typically taken for the unloaded dimension and weight of the sprung portion of the bike alone, and the difference taken. The race sag is set prior to determining the static sag.

In an embodiment, the disclosed device is adapted to enable the assessment of one or more important measurements on current model off road racing motorcycles, these measurements including—
front suspension fork-tube parallelism;
rear wheel alignment; and
rear suspension ride height.

In an embodiment, the disclosed device is a three-in-one tool that is adapted to enable the assessment of all three of the above measurements on current model off road racing motorcycles. These measurements are important settings that directly affect the handling and stability of the motorcycle and require checking and adjustment as part of the maintenance/race preparation of the motorcycle or after reassembly of particular components of the motorcycle.

While separate tools are currently available to assess front suspension fork-tube parallelism and rear suspension ride height, no one tool is adapted to provide both measurements. Further, rear wheel alignment is usually achieved via the motorcycle manufacturer indexing the rear axle mounting on either side of the rear suspension swing arm. This measurement is therefore limited by the index provided by the manufacturer. By enabling a more accurate measurement to be performed, the rear axle can be better adjusted to be parallel to the rear suspension swing arm pivot. It will be appreciated that this alignment is essential to motorcycle directional stability. In an embodiment, the ability to assess these three settings is incorporated into one device.

Referring to the drawings, an example embodiment gauge device 100 is shown for assessing at least one alignment parameter associated with a motorcycle chassis. The motorcycle chassis typically has an axle shaft, a rear suspension swing arm and a pair of front fork suspension shock absorbers. The device 100 comprises an elongate member 110, a first locating element 120 coupled to the elongate member; a second locating element 122 coupled to the elongate member,

In this embodiment, the first locating element 120 is adapted to locate an axis of the axle shaft, and the second locating element 122 is slidably coupled to the elongate member and adapted to locate a rotation axis of the rear suspension swing arm. By way of example, the first locating element 120 and second locating element 122 comprise cylindrical fittings that are machined to respectively fit within a hollow rear wheel axle and a hollow swing-arm pivot to thereby position the location elements about their respective axis. Thereby the relative location of the first locating element and second locating element is slidably adjustable for indicating the distance between the axle shaft axis and the rotation axis of a rear suspension swing arm for making a comparison of each side of the motorcycle. It will be appreciated that the fitting of a locating element within a hollow shaft can reliably locate the relative position of the respective axis for making a comparative assessment or measure.

It will be appreciated that, in alternative embodiments, the locating element can by a frusto-conical locating element, or alternatively an adjustable shape, for locating the relative position of the respective axis to make a comparative assessment or measure.

This example device 100 further comprises a pair of alignment elements 130 and 132, each coupled to the elongate member 110. Each of the pair of alignment elements is adapted to locate an axis of a respective front shock absorber (not shown). Relative location of the alignment elements is slidably adjustable for indicating the distance between front shock absorbers and comparing distances at different locations along a length of the front shock absorbers.

In this embodiment alignment elements 130 and 132 each have a ‘V’ fitting for substantially locating the alignment elements relative to the axis (or centre line) of the shock absorbers. The parallel setting of shock absorbers can be accurately achieved by comparing the measure indicated by alignment elements (and corresponding ‘V’ fittings) set relative to the axis defined by along the larger diameter outer fork-tubes and co-axial smaller diameter inner fork-tubes.

A measurement means can be provided measuring indicating movement between selected elements. In some embodiments, this movement can be directly quantitatively measured.

This example device 100 further comprises a linear distance measurement element 140 which is coupled to the elongate member for indicating relative movement between any one or more of the following,
the first locating element and the second locating element;
the first locating element and one alignment element;
the first locating element and the other alignment element;
the second locating element and one alignment element;
the second locating element and the other alignment element; and
the one alignment element and the other alignment element.

In this example, the linear distance measurement element 140 is fixedly coupled to either the second locating element 122 or the other of the pair of alignment elements 132. A measurement site element 142 is slidable relative to the elongate member 110 to an origin measure of the measurement element 140, such relative movement thereof can be directly measured. Typically, the site element 142 is fixedly coupled to either the second locating element 122 or the other of the pair of alignment elements 132, whichever is not coupled to the distance measurement element 140. While relative movement can be directly measured by the measurement of element displacement from the origin as measured at the site element 142, the gauge can provide an indicative alignment (or misalignment) measure by enabling (or not enabling) the same device configuration to measure comparable lengths. The linear distance measurement element can indicate both positive and negative displacement from the origin.

By independently coupling the second locating element 122 and the other of the pair of alignment elements 132 to the elongate element, enables relative positioning along its length that is independent of the measurement taken. By coupling the measurement element 140 to either the second locating element 122 or the other of the pair of alignment elements 132, and coupling the measurement site to the other element (122 or 132), relative movement between both the first locating element 122 and second locating element 122 and the pair of alignment elements 130 and 132 can be measured. It will be appreciated that, a direct measurement could also be obtained by providing measurement site that is positionable along to the elongate element, independent of the measurement taken, such that movement of the measurement element relative to the measurement site is indicative of the direct measurement to be taken.

A further embodiment is illustrated in FIG. 2, where corresponding features have been given the same reference numerals. However, in this embodiment the device 200 comprises an elongate member 110 that is telescopically extendable, including a first member element 212 and a second member element 214, wherein the second member element is slidably engaged to the first member element.

By way of example, the second member element is adapted to slide within a bore 315 (as best shown in FIG. 3A) of the first member element 212. However, it will be appreciated that other sliding interrelationships (or slidably coupling) can be provided.

A first locking mechanism in the form of a locking screw 250 is used to releasably lock the first locating element 212 to second locating element 214, such that relative movement there between is restricted. This first locking mechanism 250, by restricting relative movement between a first member element 212 and a second member element 214, and further restricts relative movement between a first locating element 120 and a second locating element 122.

It will be appreciated that a locking mechanism for this telescopic action of this tool can be manufactured using various methods, including: set screws, thumb screws, spring loaded pinch systems, mechanical locks, locking pins.

In this example embodiment, the first locating element is preferably fixedly attached to the first member element by threaded engagement 360 (as best shown in FIG. 3A), and the second locating element is preferably fixedly attached to the second member element by threaded engagement 362 (as best shown in FIG. 3B), whereby relative location of the first locating element and second locating element is adjustable by sliding the second member element relative to the first member element.

One of the pair of alignment elements 130 is fixedly attached to the first member element 120 by threaded engagement 360 (as best shown in FIG. 3A). The other of the pair of alignment elements 132 is preferably slidably coupled to the first member element 212, using a bore 335 defined in the alignment elements 132 for sliding over the first member element 212. Relative location of the alignment elements is adjustable by sliding the other of the pair of alignment elements 132 along the first member element 212. A second locking mechanism in the form of a locking screw 252 restricts relative movement of at least one of the pair of alignment elements and a portion of the elongate member. In this example, this locking mechanism further restricts relative movement between each of the pair of alignment elements.

In this embodiment, by way of example only, the distance measurement element 140 is fixedly coupled to the other of the pair of alignment elements 132 (as best shown in FIG. 3C), and the site element 142 is fixedly coupled to the second locating element 122. Setting the first locking mechanism 250 to restrict relative movement between a first locating element 120 and a second locating element 122, a quantitative measurement (or indicative qualitative measure) can be obtained at the site 142 for the relative movement between the pair of alignment elements 130 and 132. Setting the second locking mechanism 252 to restrict relative movement between the other of the pair of alignment elements 132 and the first member element 212, a quantitative measurement (or indicative qualitative measure) can be obtained at the site 142 for the relative movement between the first locating element 120 and the second locating element 122. By initially locating the site at the origin of the distance measurement element 140, a direct quantitative measurement can be obtained. Further, by providing a measurement site that is positionable along to the elongate element, independent of the measurement taken, movement of the measurement element relative to the measurement site is indicative of the direct measurement to be taken. The linear distance measurement element can indicate relative movement by the measurement element displacement 140 from the origin as measured at the site element 142, and can further indicate both positive and negative displacement from the origin.

It will be appreciated that the gauge can further provide an indicative alignment (or misalignment) measure by enabling (or not enabling) a set device configuration to measure lengths that are meant to be set the same.

In this embodiment, by way of example only, the device 200 can manufactured from aluminium rod, aluminium angle, hollow rectangle section aluminium and plastics.

While a production version can be constructed of an aluminium alloy, alternative materials may include: carbon fibre, plastics and plastic alloys. It will be appreciated that the material selection can be effected by cost, weight, manufacturing considerations, aesthetics and durability. Preferably, the tool can be made (in the most part) from aircraft grade 6061 Aluminium and anodized for protection against corrosion—and for aesthetics.

This example device 200 comprises a telescopic body 110 made from two sections of material, the first section 212 being of a larger cross section than the other section 214, and a lockable mechanism in the form of a set screw 250 to enable a length settable telescopic action.

It will be appreciated that the telescopic body 110 can be manufactured from rectangle section, round section, square section, triangle section or any other shaped section for the telescopic body with either two hollow sections or one hollow section and one solid section forming the telescopic body.

The telescopic body 110 is equipped a first locating element 120 and a second locating element 122, each in the form of a stepped cylindrical fitting that are set perpendicular to the main body. These cylindrical fittings are machined to fit neatly inside a respective one of either hollow swing-arm pivot or hollow rear wheel axle, thereby enabling measurement of the rear wheel alignment.

A pair of alignment elements in the form of a ‘V’ shaped fittings 130 and 132 are coupled to the telescopic body. One ‘V’ shaped fitting 130 is fixedly coupled to the rear of cylindrical first locating element 120 fitting on the larger first section 212 of the telescopic body. The other ‘V’ shaped fitting 132 is slidably coupled to the opposing end of the larger first section 212. This second ‘V’ fitting 132 also has a lockable slidable action along the first section 212.

A measurement element in the form of a ruler 140 is fixedly attached to the moveable ‘V’ fitting 132. This ruler is marked in 5 mm increments from 0 mm to 150 mm. This ruler is further adapted to align with the body of the device when assembled, and extend above the smaller section 214 of the telescopic body to the end cylindrical fitting 122. The ruler is adapted to move within a guide (including a site 142) on the rear of the cylindrical fitting. A function of this site is to register relative movement using incremental markings on the ruler. In this example the ruler is movable independently of the main telescopic action of the device using the moveable ‘V’ fitting.

A qualitative assessment is achieved by assessing the distance between the pivot and the axle on one side of the motorcycle, using the locking mechanism 250 to restrict relative movement of the locating elements 120 and 122, then comparing the distance between the pivot and the axle on the other side of the motorcycle. A quantitative assessment can be achieved by assessing the distance between the pivot and the axle on one side of the motorcycle, using the locking mechanism 252 to fixedly locate the measurement site 142 at the origin of the measurement element 140, then assesses the distance between the pivot and the axle on the other side of the motorcycle whereby relative movement locating elements 120 and 122 is indicated at the measurement site 142 as the displacement from the origin.

The diameters of the hollow swing-arm pivot and rear wheel axle can differ between various makes and models and the device can be manufactured with different diameter cylindrical fittings to fit selected motorcycles. It will be appreciated that the locating element may be interchangeable, or adapted to fit a plurality of motorcycles.

In this example, the ‘V’ fittings 130 and 32 form a fork-tube parallel gauge. Assessing the fork-tubes are parallel can be performed qualitatively by comparing the distance (or quantitatively by measuring the relative difference in distance) between a motorcycle's outer fork-tubes typically adjacent the fork tube mounting point (typically referred to as the ‘triple tree’) and the lower smaller diameter fork-tubes adjacent the front axle. As the lower fork legs are typically clamped to the front axle of the motorcycle using pinch bolts, and are freely moveable to some extent along the axle once the pinch bolts are loosened, the assessment can be completed due to the ‘V’ fittings being adapted to align with the same centre line (or axis) common to the larger diameter outer fork-tubes and the smaller diameter inner fork-tubes. Having the ‘V’ fittings defining a longitudinal channel for receiving a respective fork-tube can assist with alignment of the device such that the measure is assessed perpendicular to the axis of the fork-tubes.

A qualitatively assessment can be made by using the set screw 252 to lock the relative location of the ‘V’ fittings to indicate the distance between the fork-tubes at a first location, and assessing if the same setting is suitable to indicate the distance between the fork-tubes at a separated second location. A quantitative assessment can be made by using the set screw 252 to lock the relative location of measurement element origin to the measurement site to indicate the distance between the fork-tubes at a first location, adjusting of the location of the ‘V’ fitting 252 to fit the distance between the fork-tubes at a second location, the relative displacement can be indicated at the measurement site.

Checking of rear suspension ride heights, for example race sag and static sag, can be achieved using the chassis gauge 200. Race sag is a quantitative measurement being the difference in height between the unloaded dimension when a motorbike is supported with the rear wheel off the ground, and loaded dimension with a rider aboard (in race configuration). This static sag is a quantitative measurement being the difference in height between an unloaded dimension and the weight of the sprung portion of the bike alone (without a rider's weight).

In this embodiment, the race sag measurement is achieved by first raising the motorcycle off the ground allowing the suspension and wheels to hang freely without touching the ground. The cylindrical fitting 120 is inserted into the rear axle and the tool positioned vertically and extended until the other cylindrical fitting 122 comes into contact with a location on underside of the motorcycle rear mudguard. The origin of the ruler 140 is positioned within the site by sliding the ‘V’ fitting 132, such that the origin mark registers in the site—thereby registering an unloaded dimension. The ‘V’ fitting 132 is locked using the locking mechanism 252, thereby locking the origin in the site indicative of the rear suspension fully extended length. To assist with establishing this configuration, the main telescopic body 110 can also be locked at this length, using the locking mechanism 250.

The motorcycle is now placed on the ground with the wheels bearing the weight of the motorcycle. The distance that the rear suspension compresses under the weight of the bike alone can be measured by inserting the cylindrical fitting 120 into the rear axle and positioning the tool until the other cylindrical fitting 122 comes into contact with the previous location on underside of the motorcycle rear mudguard. If the main telescopic body 110 was locked, it can be unlocked by releasing the locking mechanism 250. The relative difference in height is now indicated by the ruler 140 at the measurement site 142.

Static sag can be measured as the displacement without a rider sitting on the motorbike, and race sag can be measured with a rider sitting on the motorbike. The Motorcycle manufacturer sets this specification and allows adjustment of the rear spring preload to allow for the correct sag measurements for varying rider weights. To obtain accurate static and race sag measurements, the registration of the unloaded dimension can be reset after each adjustment of the suspension. It will be appreciated that, where the unloaded dimension is substantially defined by the maximum stroke length of the rear shock absorber assembly, resetting the unloaded dimension may not be necessary.

A further embodiment is illustrated in FIG. 4, where corresponding features have been given the same reference numerals. In this embodiment the device 400 comprises an elongate member 110 that is telescopically extendable, including a first member element 212 and a second member element 214, wherein the second member element is slidably engaged to the first member element. The first member has a ‘C’ channel portion for receiving the second member element, thereby enabling the second member element to be at least partially viewed along its length. A measurement element in the form of a ruler 140 is integrally formed with second member element 214 (as best shown in FIG. 5C). This ruler is marked in increments, indicates both positive and negative displacement from an origin An alignment element 132 (including a site 142) is adapted to slidably move along first member element 212. A function of this site is to register relative movement using incremental markings on the ruler. In this example the ruler moves as part of the main telescopic action of the device, whereas the site is movable independently of the main telescopic action using the moveable ‘V’ fitting 132.

FIG. 5A shows the first member element 212 couplable to the first locating element 120 and one of a pair of alignment elements 130. The first member element 212 has a ‘C’ channel portion defining a recess 315 for receiving the second member element.

FIG. 5B shows other of a pair of alignment elements 132 having a bore 335 adapted to slidably engage the first member element 212.

FIG. 5C shows the second member element 214 couplable to a second locating element 122. In this embodiment, the linear distance measurement element 140 is integrally formed with a second member element.

It will be appreciated that the method of making both qualitative and quantitative measures using the device 400, is similar to that described for device 200.

It will be further appreciated that the illustrated devices are adapted to enable fast and accurate chassis set up of motorbikes. By way of example only, these devices are suitable for motocross and/or enduro motorbikes, such as Yamaha YZ-F and WR-F, Honda CRF, Suzuki RM-Z and Kawasaki KX-F. This device is further adaptable to specific motorcycle models by utilising attachable adapters and universal fittings. This device can be provided in the form of a kit suitable to a range of motorbike models, thereby making it more suitable for a technician and/or workshops.

It will be appreciated that the illustrated mechanical gauge is adapted to assess a plurality of alignment parameters associated with a motorcycle chassis.

Although the invention has been described with reference to specific examples, it will be appreciated by those skilled in the art that the invention may be embodied in many other forms.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

In the claims and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

We claim:

1. A gauge device for assessing at least one alignment parameter associated with a motorcycle chassis, the motorcycle chassis having an axle shaft, a rear suspension swing arm and a pair of front fork suspension shock absorbers, the device comprising:
an elongate member;
a first locating element coupled to the elongate member and adapted to locate an axis of the axle shaft;
a second locating element coupled to the elongate member and adapted to locate a rotation axis of the rear suspension swing arm;
wherein relative location of the first locating element to the second locating element is adjustable for indicating the distance between the axle shaft axis and the rotation axis of a rear suspension swing arm for comparison at each side of the motorcycle.

2. The device of claim 1, further comprising:
a pair of alignment elements each coupled to the elongate member, each of the pair of alignment elements is adapted to locate an axis of a respective one of the front shock absorbers;
wherein relative location of the alignment elements is adjustable for indicating the distance between front shock absorbers and comparing distances at different locations along a length of the front shock absorbers.

3. The device of claim 1, wherein the second locating element is adapted to abut a rear mud guard of the motorbike and is movable for assessing any one or more of rear suspension ride height, static sag and race sag.

4. The device of claim 2, wherein the least one of the pair of alignment elements is adapted to abut a rear mud guard of the motorbike and movable for assessing any one or more of rear suspension ride height, static sag and race sag.

5. The device of claim 2, wherein the elongate member comprises a first member element and a second member element; the second member element being slidably engaged to the first member element, such that the elongate member is telescopically extendable.

6. The device of claim 5, wherein the first locating element is fixedly couplable to the first member element and the second locating element is fixedly couplable to the second member element, wherein relative location of the first locating element and second locating element is adjustable by sliding the second member element relative to the first member element.

7. The device of claim 5, wherein one of the pair of alignment elements is fixedly couplable to the first member element, and the other of the pair of alignment elements is couplable to the first member element, whereby relative location of the alignment elements is adjustable by sliding the other of the pair of alignment elements along the first member element.

8. The device of claim 6, wherein one of the pair of alignment elements is fixedly couplable to the first member element, and the other of the pair of alignment elements is fixedly couplable to the second member element, whereby is adjustable by sliding the second member element relative to the first member element.

9. The device of claim 5 further comprising:
a linear distance measurement element coupled to the elongate member for indicating relative movement between the first member element and the second member element.

10. The device of claim 9, wherein the linear distance measurement element is adapted to directly measure relative movement.

11. The device of claim 9, wherein the linear distance measurement element is adapted to measure both positive and negative relative movement from a preset datum.

12. The device of claim 6 further comprising:
a linear distance measurement element coupled to the elongate member for indicating relative movement between the first locating element and the second locating element.

13. The device of claim 7 further comprising:
a linear distance measurement element coupled to the elongate member for indicating relative movement between each of the pair of alignment elements.

14. The device of claim 8 further comprising:
a linear distance measurement element coupled to the elongate member for indicating relative movement between the first member element and the second member element.

15. The device of claim 5, wherein the device is adapted to assessing at least three alignment parameters associated with a motorcycle chassis, the alignment parameter comprising:
parallelism of front shock absorbers, rear axle alignment as indicated by distance between the axle shaft axis and the rotation axis of a rear suspension swing arm, and any one or more of rear suspension ride height, static sag and race sag.

16. A gauge device for assessing at least one alignment parameter associated with a motorcycle chassis, the motorcycle chassis having an axle shaft, a rear suspension swing arm and a pair of front fork suspension shock absorbers, the device comprising:
an elongate member, the elongate member comprising a first member element and a second member element, the second member element being slidably engaged to the first member element such that the elongate member is telescopically extendable;
a pair of alignment elements each coupled to the elongate member, each of the pair of alignment elements is adapted to locate an axis of a respective one of the front shock absorbers;
wherein relative location of the alignment elements is adjustable for indicating the distance between front shock absorbers and comparing distances at different locations along a length of the front shock absorbers.

17. The device of claim 16, further comprising:
a first locating element coupled to the elongate member and adapted to locate an axis of the axle shaft;
a second locating element coupled to the elongate member and adapted to locate a rotation axis of the rear suspension swing arm;
wherein relative location of the first locating element to the second locating element is adjustable for indicating the distance between the axle shaft axis and the rotation axis of a rear suspension swing arm for comparison at each side of the motorcycle;
wherein the device is adapted to assessing at least three alignment parameters associated with a motorcycle chassis, the alignment parameter comprising: parallelism of front shock absorbers, rear axle alignment as indicated by distance between the axle shaft axis and the rotation axis of a rear suspension swing arm, and any one or more of rear suspension ride height, static sag and race sag.

18. The device of claim 17 further comprising:
a linear distance measurement element coupled to the elongate member for indicating relative movement between the first member element and the second member element.

19. A gauge device for assessing at least one alignment parameter associated with a motorcycle chassis, the motorcycle chassis having an axle shaft, a rear suspension swing arm and a pair of front fork suspension shock absorbers, the device comprising:
an elongate member, the elongate member comprising a first member element and a second member element, the second member element being slidably engaged to the first member element such that the elongate member is telescopically extendable;
a first locating element coupled to the elongate member and adapted to locate an axis of the axle shaft;
a second locating element coupled to the elongate member and adapted to locate a rotation axis of the rear suspension swing arm;
a pair of alignment elements each coupled to the elongate member, each of the pair of alignment elements is adapted to locate an axis of a respective one of the front shock absorbers; and
a linear distance measurement element coupled to the elongate member for indicating relative movement between the first member element and the second member element;
wherein relative location of the first locating element to the second locating element is adjustable for indicating the distance between the axle shaft axis and the rotation axis of a rear suspension swing arm for comparison at each side of the motorcycle;
wherein relative location of the alignment elements is adjustable for indicating the distance between front shock absorbers and comparing distances at different locations along a length of the front shock absorbers.

20. The device of claim 19, wherein the device is adapted to assess at least three alignment parameters associated with a motorcycle chassis, the alignment parameter comprising:
parallelism of front shock absorbers, rear axle alignment as indicated by distance between the axle shaft axis and the rotation axis of a rear suspension swing arm, and any one or more of rear suspension ride height, static sag and race sag.
